(19) United States
(12) Patent Application Publication
(10) Pub. No.: US 2016/0345229 A1
(43) Pub. Date: Nov. 24, 2016

(54) WLAN AND WWAN COOPERATIVE SUPPORT OF WWAN FUNCTIONALITY

(71) Applicant: QUALCOMM Incorporated, San Diego, CA (US)

(72) Inventors: Soumya Das, San Diego, CA (US); Bongyong Song, San Diego, CA (US); Samir Salib Soliman, Poway, CA (US)

(21) Appl. No.: 14/719,591

(22) Filed: May 22, 2015

(51) Int. Cl. H04W 36/30; H04W 24/08

(52) U.S. Cl. CPC H04W 36/30; H04W 24/08; H04W 84/12

(57) ABSTRACT

A receive (Rx) chain of a wireless local area network (WLAN) transceiver may be used to assist a wireless wide area network (WWAN) transceiver in a user equipment (UE). A UE may use the WLAN Rx chain to autonomously scan and measure while the UE is connected to a first or home wireless network using its WWAN transceiver. When the UE is in a connected state, the WLAN Rx chain may be used to scan and take measurements for one or more second networks operated by a second wireless operator belonging to the same mobile virtual network operator (MVNO) as the first wireless network. In another example, the WLAN Rx chain may perform a set of inter-frequency reference signal time difference (RSTD) measurements based on observed time offsets between positioning reference signals (PRSs) from neighboring cells.

### BACKGROUND

Field of the Disclosure

The present disclosure, for example, relates to wireless communication systems, and more particularly using the receive (Rx) chain of a wireless local area network (WLAN) transceiver to scan one or more wireless wide area networks (WWANs) to cooperatively support a WWAN transceiver connected to a first or home network, where both the WLAN and WWAN transceivers are of a single UE having multiple-radio access technologies (RATs) capabilities.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, space and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

By way of example, a wireless multiple-access communication system may include a number of base stations or access points, each simultaneously supporting communication for multiple communication devices, otherwise known as user equipments (UEs). UEs may contain multiple radios or transceivers, each configured to support various radio access technologies. A base station or access point may communicate with UEs on downlink channels (e.g., for transmissions from a base station to a UE) and uplink channels (e.g., for transmissions from a UE to a base station). Communication between a UE and a base station may use a wireless wide area network (WWAN), while communication between a UE and an access point may use a wireless local area network (WLAN). Wi-Fi and Bluetooth are examples of WLAN technologies that may be supported by a UE. UEs typically include different WWAN and WLAN transmit (Tx) and receive (Rx) chains. For example, a UE may have one or more Tx and Rx chains used for WWAN transmissions/receptions, and may also have separate Tx and Rx chains used for WLAN transmissions/receptions.

Although WWAN and WLAN transceivers may initially be designed for specific communication needs, with advances in technology and a need for higher data rates, the use of specific transceivers for particular RATs has begun to change. It is possible to use a WLAN transceiver when it is available to assist the WWAN modem with certain functionalities typically done by the WWAN transceiver using the WLAN transceiver.

UEs may be used in connection with a mobile virtual network operator (MVNO). A MVNO is a wireless communications services provider that does not own the wireless network infrastructure over which the MVNO provides services to its customers. Thus, a MVNO may enter into a business agreement with one or more mobile network operators to obtain bulk access to network services. However, when a MVNO contracts with multiple mobile network operators, meaning that the mobile virtual network may actually include multiple actual networks, the actual networks may not configure the UE in connected state for measurements of other actual networks associated with the MVNO even when the signal quality is degraded.

UEs may also help make measurements for purposes of mobility, load balancing and offloading, and positioning of the UE. Such measurements may be made for neighboring cells of a wireless network on the same frequency as the serving frequency for the UE or on a different frequency or frequencies. One such measurement type is an observed time difference of arrival (OTDOA) measurement used to estimate a UE's position. An OTDOA measurement may be based on UE estimates of time differences between when the UE receives a number of positioning reference signals (PRSs) from the neighboring cells. Such measurements may be used for, among other things, enhanced 911 services.

### SUMMARY

A receive (Rx) chain of a wireless local area network (WLAN) transceiver may be used to assist a wireless wide area network (WWAN) transceiver in a user equipment (UE). A UE may use the WLAN Rx chain to autonomously scan and measure while the UE is connected to a first (home) wireless network using its WWAN transceiver. When the UE is in a connected state, a Rx chain of a WLAN transceiver may be used to take measurement for one or more second networks operated by a second wireless operator belonging to the same mobile virtual network operator (MVNO) as the first wireless network, so as to not interrupt communications with the connected home network. The WLAN Rx chain may also perform a set of inter-frequency reference signal time difference (RSTD) measurements based on observed time offsets between positioning reference signals (PRSs) from neighboring cells in response to an observed time difference of arrival (OTDOA) request to assist the WWAN transceiver, which performs the intra-frequency measurements.

In a first set of illustrative examples, a method for wireless communication is described. In one example, the method may include communicating with a first WWAN operated by a first operator of a MVNO, the communicating using a WWAN transceiver of a UE; and scanning a second WWAN operated by a second operator of the MVNO, the scanning using a WLAN transceiver of the UE.

In some examples of the method, the method also includes initiating the scanning of the second WWAN when a signal strength of the first WWAN falls below a threshold. In some examples of the method, the method also includes transitioning communication from the first WWAN to the second WWAN when a signal strength of the second WWAN exceeds a first threshold. In some examples of the method, scanning the second WWAN using the WLAN transceiver includes scanning the second WWAN using a receive chain of the WLAN transceiver.

In some examples of the method, the method also includes communicating with a WLAN using the WLAN transceiver during a first period; and delaying scanning the second WWAN using a receive chain of the WLAN transceiver until after the first period. In some examples of the method, communicating with the WLAN using the WLAN transceiver during the first period further includes receiving delay sensitive traffic. In some examples of the method, the method also includes communicating with the WLAN using the WLAN transceiver during the first period further includes receiving voice traffic, video traffic, or both voice and video traffic.

In some examples of the method, the method also includes communicating with a WLAN using the WLAN transceiver during a first period and a second period immediately following the first period; and scanning the second WWAN using the WWAN transceiver during the second period when the first period exceeds a threshold. In some examples of the method, the method also includes storing an identifying information for a plurality of cells in the second WWAN. In some examples of the method, the identifying information includes at least one of band, bandwidth, or channel number information. In some examples of the method, the method also includes storing identifying information for one or more cells to which the UE has previously been connected. In some examples of the method, the method also includes retrieving, from a WWAN server, identifying information for a plurality of cells in the second WWAN.

In some examples of the method, the method also includes transitioning communication from the first WWAN to the second WWAN if a second signal strength of the second WWAN exceeds a first threshold and a first signal strength of the first WWAN remains below a second threshold for a predetermined period of time. In some examples of the method, scanning the second WWAN is initiated based at least in part on an internal trigger of the UE. In some examples of the method, scanning the second WWAN is not based on a configuration received from the second WWAN.

In a second set of illustrative examples, an apparatus for wireless communication is described. In one example, the apparatus may include a processor; memory in electronic communication with the processor; and instructions stored in the memory, the instructions being executable by the processor to: communicate with a first WWAN operated by a first operator of a MVNO, the communicating using a WWAN transceiver of a UE; and scan a second WWAN operated by a second operator of the MVNO, the scanning using a WLAN transceiver of the UE. The instructions stored in the memory may further include instructions executable by the processor to initiate scanning of the second WWAN when a signal strength of the first WWAN falls below a threshold. The instructions stored in the memory may further include instructions executable by the processor to transition communication from the first WWAN to the second WWAN when a signal strength of the second WWAN exceeds a first threshold. The instructions stored in the memory may further include instructions executable by the processor to scan the second WWAN using a receive chain of the WLAN transceiver.

In a third set of illustrative examples, a method for wireless communication is described. In one example, the method may include performing a first plurality of RSTD measurements for a first plurality of cells of a WWAN using a WWAN transceiver of a UE; and performing a second plurality of RSTD measurements for a second plurality of cells of the WWAN using a WLAN transceiver of the UE.

In some examples of the method, the method also includes performing the first plurality of RSTD measurements includes sampling a first plurality of PRSs, wherein each of the plurality of PRSs originates from one of the first plurality of cells; and performing the second plurality of RSTD measurements includes sampling a second plurality of PRSs, wherein each of the second plurality of PRSs originates from one of the second plurality of cells. In some examples of the method, the method also includes receiving OTDOA assistance data from a neighboring cell; and triggering the performing of the second plurality of RSTD measurements based on the OTDOA assistance data. In some examples of the method, the first plurality of RSTD measurements are intra-frequency RSTD measurements and the second plurality of RSTD measurements are inter-frequency RSTD measurements. In some examples of the method, the method also includes processing the second plurality of RSTD measurements in a WLAN transceiver chain. In some examples of the method, the method also includes processing the second plurality of RSTD measurements with a WWAN modem. In some examples of the method, the method also includes performing the first plurality of RSTD measurements over a first period; performing the second plurality of RSTD measurements over a second period, wherein the first period overlaps the second period. In some examples of the method, the method also includes increasing a number of cells of the WWAN on which to perform a RSTD measurement to comply with a United States Federal Communications Commission enhanced 911 standard.

In a fourth set of illustrative examples, another apparatus for wireless communication is described. In one example, the apparatus may include a processor; memory in electronic communication with the processor; and instructions stored in the memory, the instructions being executable by the processor to: perform a first plurality of RSTD measurements for a first plurality of cells of a WWAN using a WWAN transceiver of a UE; and performing a second plurality of RSTD measurements for a second plurality of cells of the WWAN using a WLAN transceiver of the UE. The instructions stored in the memory may further include instructions executable by the processor to perform the first plurality of RSTD measurements includes sampling a first plurality of PRSs, wherein each of the plurality of PRSs originates from one of the first plurality of cells; and perform the second plurality of RSTD measurements includes sampling a second plurality of PRSs, wherein each of the second plurality of PRSs originates from one of the second plurality of cells. The instructions stored in the memory may further include instructions executable by the processor to receive OTDOA assistance data from a neighboring cell; and trigger the performing of the second plurality of RSTD measurements based on the OTDOA assistance data.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system, in accordance with various aspects of the present disclosure;

FIG. 2A illustrates a system diagram that shows an example of a wireless communications system, in accordance with various aspects of the present disclosure;

FIG. 2B shows a block diagram of a UE for use in wireless communications, in accordance with various aspects of the present disclosure;

FIG. 3A illustrates a geographic coverage area diagram for a base station of a first wireless network operated by a first wireless operator belonging to an MVNO, in accordance with various aspects of the present disclosure;

FIG. 3B illustrates a geographic coverage area diagram for a base station of a second wireless network operated by a second wireless operator belonging to the same MVNO as the first wireless network operator, in accordance with various aspects of the present disclosure;

FIG. 3C illustrates a combined geographic coverage area diagram for the first base station and the second base station, in accordance with various aspects of the present disclosure;

FIG. 4 shows a first example message flow between a UE, a serving base station and a plurality of non-serving base stations, in accordance with various aspects of the present disclosure;

FIG. 5 shows a second example message flow between a UE, a serving base station and a plurality of non-serving base stations, in accordance with various aspects of the present disclosure;

FIG. 6 shows a block diagram of an apparatus for use in wireless communication, in accordance with various aspects of the present disclosure;

FIG. 7 shows a block diagram of a device for use in wireless communication, in accordance with various aspects of the present disclosure;

FIG. 8 shows a system for use in wireless communication, in accordance with various aspects of the present disclosure;

FIG. 9 is a flow chart illustrating a first example of a method for wireless communication, in accordance with various aspects of the present disclosure;

FIG. 10 is a flow chart illustrating a second example of a method for wireless communication, in accordance with various aspects of the present disclosure;

FIG. 11 is a flow chart illustrating a third example of a method for wireless communication, in accordance with various aspects of the present disclosure; and

FIG. 12 is a flow chart illustrating a fourth example of a method for wireless communication, in accordance with various aspects of the present disclosure.

### DETAILED DESCRIPTION

Wireless wide area network (WWAN) and wireless local area network (WLAN) transceivers of a user equipment (UE) may initially be designed for specific communication needs. A WWAN transceiver may perform scanning or measurement functions on both its first or home network and on wireless networks other than its home network. While the WWAN transceiver alone may be able to handle these functions while a UE is in an idle or standby state, these other functions can disrupt communications when a WWAN transceiver is actively communicating with its home network. Where the UE is operating in a mobile virtual network operator (MVNO) scenario, a WWAN transceiver connected to its home network may also be unable to concurrently configure measurements on its home network and on a second network. In addition, for certain time-sensitive measurement functions, such as those used for determining a UE position for purposes of enhanced 911 services, a single WWAN transceiver may not be able to take sufficient measurements within a given time. A WWAN transceiver may be used to take a number of measurements of neighboring cells of the serving cell to estimate a UE's position. A UE may perform a set of reference signal time difference (RSTD) measurements based on observed time offsets between positioning reference signals (PRSs) from different neighboring cells either on the same frequency or different frequency as that of the serving cell. As further explained below, however, an inadequate number of neighboring cells, PRS measurement occasions on other frequencies that overlap with that on the serving frequency, and/or requirements for multiple measurements of the same cell may increase delay where only a single WWAN transceiver is used for the RSTD measurements. To help address these issues, a second WWAN transceiver could be used to supplement the resources of the first WWAN transceiver, but reusing WLAN resources, including a receive (Rx) chain of a WLAN transceiver, typically used for WLAN communication functions such as Wi-Fi and/or Bluetooth may be more cost efficient. However, as with an active WWAN transceiver, it may be desirable to minimize the impact of reusing the WLAN resources on any active WLAN communication functions.

A Rx chain of a WLAN transceiver may be used to assist a WWAN transceiver in a UE. A UE may use the WLAN Rx chain to autonomously measure or scan one or more second wireless networks while the UE is connected to a first (home) wireless network using its WWAN transceiver. When the UE is in a connected state, the WLAN Rx chain may be used to take measurements for one or more second (neighbor) wireless networks so as to not interrupt communications with the connected home network or otherwise aid in WWAN communications.

One specific example is operation of a UE in a MVNO environment. The UE may use an Rx chain of a WLAN transceiver to autonomously measure or scan another, second wireless network while the UE is actively connected to a first wireless network using its WWAN transceiver. For example, whenever a connected UE detects that the performance of the first wireless network operated by the first wireless operator belonging to a MVNO is below a threshold level including the signal strength of the serving first wireless network below a certain threshold, the UE may use the WLAN Rx chain to scan for a second wireless network operated by the second wireless operator belonging to the same MVNO. If the performance on the first wireless network does not improve within a pre-configured time, the UE may be configured to drop the current connection with the first wireless network operated by the first wireless operator (via the WWAN transceiver) and establish a new connection with the second wireless network operated by the second wireless operator (via the WWAN transceiver). Scanning using the WLAN Rx chain may also be delayed if the UE is using the WLAN transceiver for high-priority, delay-sensitive traffic when scanning would otherwise occur.

A second specific example is operation of a Rx chain of a WLAN transceiver in a first wireless network to assist a WWAN transceiver in the UE in the context of taking inter-frequency measurements from a number of base stations that may be used to identify a UE's position. One such measurement type is an observed time difference of arrival (OTDOA) measurement used to estimate a UE's position. An OTDOA measurement may be based on UE estimates of time differences between when the UE receives a number of positioning reference signals (PRSs) from the neighboring cells on the same frequency or different frequency as that of the serving cell. The UE may perform a set of reference signal time difference (RSTD) measurements based on observed time offsets between the PRSs from the different cells of the list of cells that the UE was able to measure. The WWAN transceiver may perform intra-frequency RSTD measurements, while the WLAN transceiver may concurrently perform inter-frequency RSTD measurements. Intra-frequency RSTD measurements are those performed for the various cells using PRSs carried on the same frequency as that of the serving cell. In contrast, inter-frequency RSTD measurements use PRSs carried on different frequencies from that of the serving cell. By using the WLAN transceiver to assist the WWAN transceiver in the measurement process, position accuracy may be increased and/or measurement time decreased.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

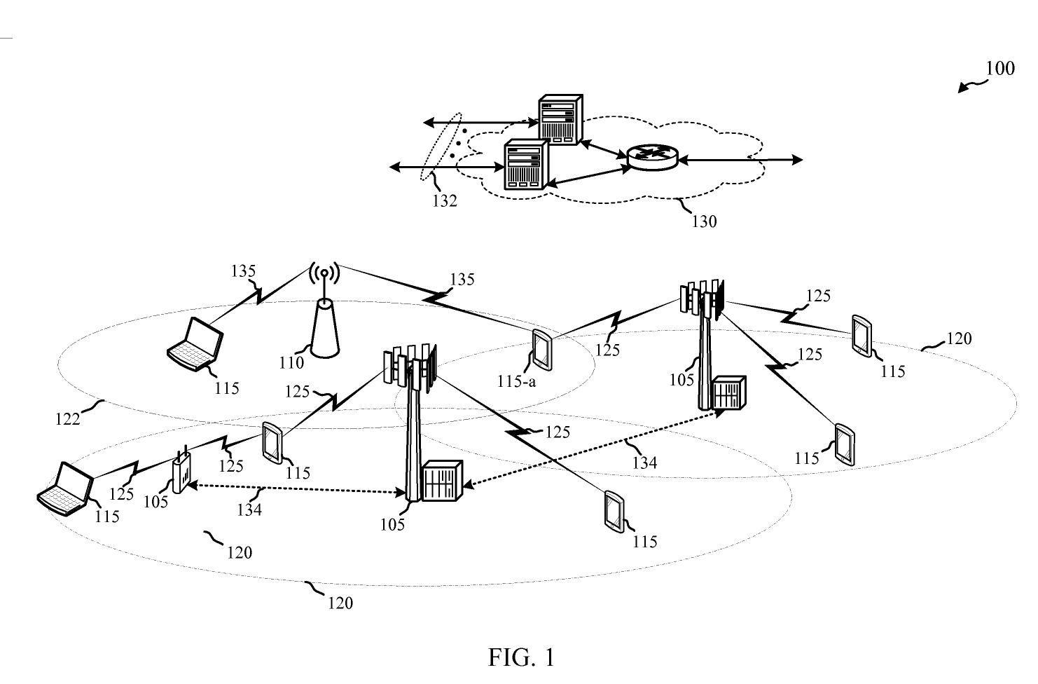

Referring first to FIG. 1, a system diagram illustrates an example of a wireless communications system 100. The wireless communications system 100 may include base station(s) 105, access point(s) (AP) 110, and mobile devices such as UEs 115. The AP 110 may provide wireless communications via a WLAN radio access network (RAN) such as, e.g., a network implementing at least one of the IEEE 802.11 family of standards. The AP 110 may provide, for example, WLAN or other short range (e.g., Bluetooth and Zigbee) communications access to a UE 115. Each AP 110 has a geographic coverage area 122 such that UEs 115 within that area can typically communicate with the AP 110. UEs 115 may be multi-access mobile devices that communicate with the AP 110 and a base station 105 via different radio access networks. The UEs 115, such as mobile stations, personal digital assistants (PDAs), other handheld devices, netbooks, notebook computers, tablet computers, laptops, display devices (e.g., TVs, computer monitors, etc.), printers, etc., may be stationary or mobile and traverse the geographic coverage areas 122 and/or 120, the geographic coverage area of a base station 105. While only one AP 110 is illustrated, the wireless communications system 100 may include multiple APs 110. Some or all of the UEs 115 may associate and communicate with an AP 110 via a communication link 135 and/or with a base station 105 via a communication link 125.

The wireless communications system 100 may also include a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

A UE 115 can be covered by more than one AP 110 and/or base station 105 and can therefore associate with multiple APs 110 or base stations 105 at different times. For example, a single AP 110 and an associated set of UEs 115 may be referred to as a basic service set (BSS). An extended service set (ESS) is a set of connected BSSs. A distribution system (DS) (not shown) is used to connect APs 110 in an extended service set. A geographic coverage area 122 for an access point 110 may be divided into sectors making up only a portion of the geographic coverage area (not shown). The wireless communications system 100 may include APs 110 of different types (e.g., metropolitan area, home network, etc.), with varying sizes of geographic coverage areas and overlapping geographic coverage areas for different technologies. Although not shown, other wireless devices can communicate with the AP 110.

The base stations 105 may wirelessly communicate with the UEs 115 via base station antennas. Each of the base station 105 sites may provide communication coverage for a respective geographic coverage area 120. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 120 for a base station 105 may be divided into sectors making up only a portion of the geographic coverage area (not shown). The wireless communications system 100 may include base stations 105 of different types (e.g., macro and/or small cell base stations). There may be overlapping geographic coverage areas 120/122 for different technologies.

In some examples, the wireless communications system 100 includes portions of an LTE/LTE-Advanced (LTE-A) network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a geographic coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARD) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with various types of base stations and network equipment including macro eNBs, small cell eNBs, relay base stations, APs, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include at least one carrier, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined. Similarly, communication links 135, also shown in wireless communications system 100, may include UL transmissions from a UE 115 to an access point 110, and/or DL transmissions from an access point 110 to a UE 115.

In some embodiments of the system 100, base stations 105, APs 110, and/or UEs 115 may include multiple antennas for employing antenna diversity schemes to improve communication quality and reliability between base stations 105, APs 110, and UEs 115. Additionally or alternatively, base stations 105, APs 110, and/or UEs 115 may employ multiple-input, multiple-output (MIMO) techniques that may take advantage of multi-path environments to transmit multiple spatial layers carrying the same or different coded data.

System 100 includes a UE 115-a which is in communication with both a base station 105 and an access point 110. As an example, UE 115-a may communicate with the access point 110 using Wi-Fi or other WLAN communications, while the UE 115-a may communicate with the base stations 105 using LTE, GSM, or other WWAN communications. The communications may be at the same time. As an example, the UE 115-a may be a dual subscriber identity module (SIM) dual active (DSDA) or multiple SIM multiple active (MSMA) device having a first SIM (SIM1) and a second SIM (SIM2) and may communicate with one base station 105 using LTE communications for SIM1, another base station 105 using GSM communications for SIM2, and an access point 110 using Wi-Fi communications. As another example, the UE 115-a may communicate with one base station 105 using LTE communications for SIM1, the same base station 105 using GSM communications for SIM2, and an access point 110 using Wi-Fi communications.

The UE 115-a may include a single WWAN Tx and Rx chain that may be shared between multiple WWAN functions. For example, a first WWAN function (such as an LTE communication or other WWAN communication, or RSTD or other signal measurement) may utilize the WWAN Rx chain during a first time period, and a second WWAN function (such as scanning a second wireless network of a MVNO, or taking RSTD measurements) may utilize the WWAN Rx chain during a second time period. When the WWAN Rx chain is being actively utilized for other WWAN functions such as RSTD measurements or MVNO scanning, a WWAN communication may be disrupted because the WWAN Tx or Rx chains may be unavailable. Therefore, while the multiple WWAN functions are occurring, the UE 115-a may utilize a portion of a WLAN module in the UE to support the second WWAN functions while the WWAN module may support the first WWAN functions. In this way, the availability of the single WWAN Tx and Rx chains may be increased. However, the WLAN module in the UE 115-a may also often be in communication with an access point 110 using Wi-Fi, Bluetooth, or other WLAN communications. Overuse of the WLAN module in the UE 115-a to support additional WWAN functions may degrade UE performance. For example, WLAN throughput for Wi-Fi may be adversely affected by MVNO scanning or RSTD measurements when supported by the WLAN module.

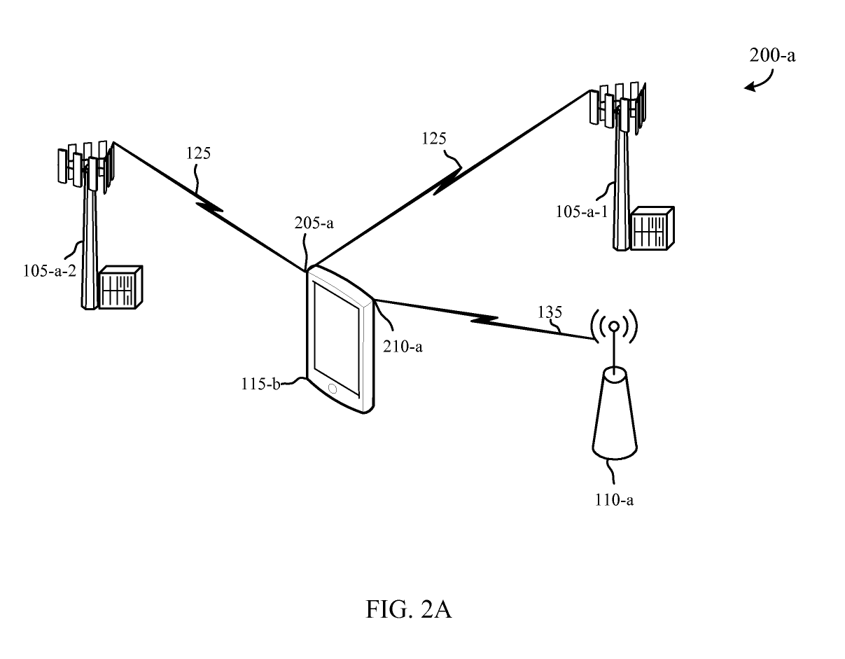

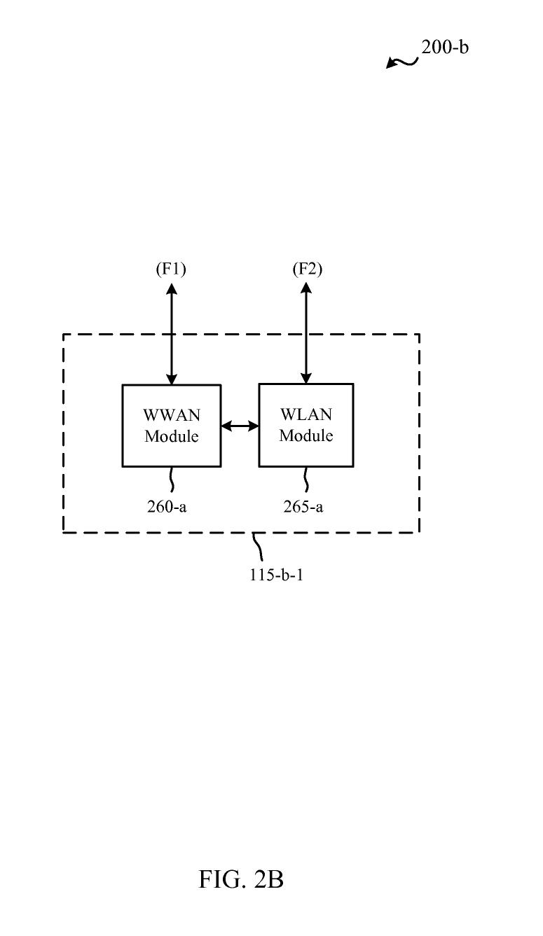

FIG. 2A illustrates a system diagram that shows an example of a wireless communications system 200-a. The wireless communications system 200-a may include base stations 105-a−1, 105-a−2, access point 110-a and UE 115-b. The UE 115-b may be an example of UE 115-a in system 100 of FIG. 1 and may be engaged in both WWAN and WLAN communications. The base stations 105-a−1, 105-a−2 may be examples of base stations 105 included in system 100 of FIG. 1, and the access point 110-a may be an example of the access point 110 in system 100 of FIG. 1.

In system 200-a, the UE 115-b may include at least two different sets of antennas, WWAN antennas 205-a and WLAN antennas 210-a. For example, WWAN antennas 205-a may be a WWAN antenna associated with a WWAN module. Using the WWAN antennas 205-a, the UE 115-b may engage in WWAN communications with base station 105-a−1 and base station 105-a−2 via communication links 125. The WWAN antennas 205-a and associated WWAN module may include both Tx and Rx chains used during WWAN communications. The WWAN antennas 205-a may include one or more diversity WWAN antennas for WWAN communications with base station 105-a−1 and/or base station 105-a−2, where each WWAN communication supports a different SIM. The one or more diversity WWAN antennas 205-a may also be used for WWAN communications with base station 105-a−1 and/or base station 105-a−2, where the WWAN communication supports one SIM in a carrier aggregation (CA) or multi-carrier mode.

In system 200-a, the UE 115-b may use the WLAN antennas 210-a to communicate with the access point 110-a (via communication link 135). The communications with the access point 110-a may be Wi-Fi or other WLAN communications. As described in greater detail below, both the WWAN communications and the WLAN communications may share portions of the Tx and Rx chains of a WLAN module associated with the WLAN antennas 210-a. For example, while a WWAN communication from base station 105-a−1 may be received by the WWAN antennas 205, the WWAN communication may be processed by a portion of the WLAN Rx chain while the WWAN Rx chain is processing a different WWAN communication from base station 105-a−2. Examples of received communications may include OTDOA requests, OTDOA assistance data, and reference signals, including PRSs. Similarly, a WWAN communication may be processed by a portion of the WLAN Tx chain that may be transmitted to base station 105-a−1 using WWAN antennas 205-a while the WWAN Tx chain is processing a different WWAN communication that may be transmitted to base station 105-a−2 using WWAN antennas 205-a. Examples of transmitted communications may include RSTD measurements and other messaging responsive to an OTDOA request.

FIG. 2B shows a system 200-b of a UE 115-b−1 for use in wireless communications, in accordance with various aspects of the present disclosure. The UE 115-b−1 may include a WWAN module 260-a and a WLAN module 265-a. The WWAN module 260-a may facilitate communications over a WWAN. The WWAN module 260-a may support communications within a first frequency bandwidth F1 or first RAT. The WLAN module 265-a may facilitate communications over a WLAN. The WLAN module 265-a may support communications within a second frequency bandwidth F2 or second RAT. In some examples the first frequency bandwidth F1 and the second frequency bandwidth F2 may be adjacent bandwidths. In these examples, the UE 115-b−1 may send and/or receive WWAN communications using components of the WLAN module 265-a.

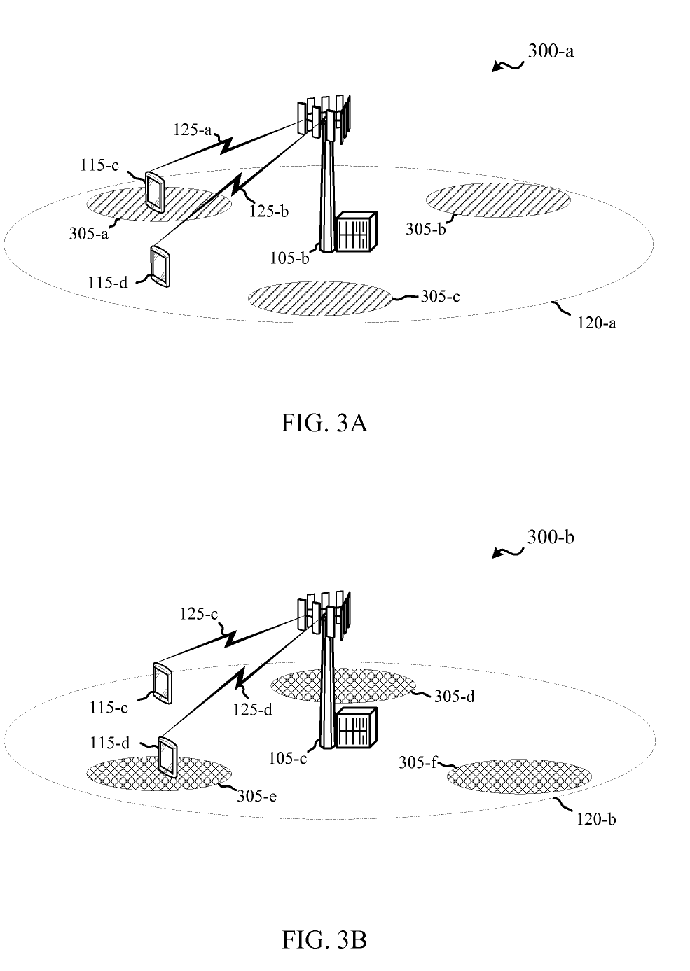

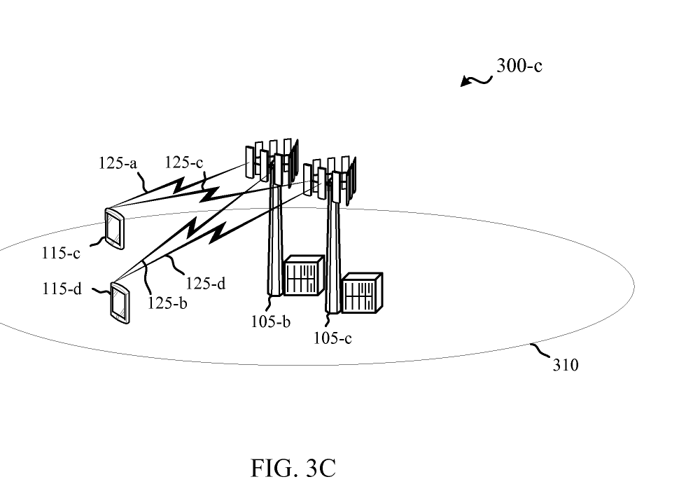

FIG. 3A illustrates a geographic coverage area diagram 300-a for a base station of a first wireless network operated by a first wireless operator belonging to an MVNO, in accordance with various aspects of the present disclosure. Geographic coverage area 120-a is served by associated base station 105-b, which may be provided by a first wireless network operator. At any particular time, areas within geographic coverage area 120-a may be conceptually divided into geographic areas of strong coverage, where a signal strength is above a signal strength threshold, and geographic areas of weak coverage, where a signal strength is below the signal strength threshold. There may also be multiple thresholds to divide up a geographic coverage area 120-a at a particular time into three or more types of geographic areas, for example areas of weak, medium, or strong coverage. Thresholds may also have a time period component, where the signal strength may be measured over a predetermined period of time. Weak geographic coverage areas 305-a, 305-b, and 305-c represent geographic areas within geographic coverage area 120-a where a measured signal strength falls below a threshold. Geographic coverage area 120-a has strong coverage apart from weak geographic coverage areas 305-a, 305-b, and 305-c. Therefore, UE 115-c and UE 115-d, which may access the first wireless network, may be in areas of weak coverage or strong coverage within geographic coverage area 120-a provided by the first wireless network operator. At a particular time, UE 115-c is within weak geographic coverage areas 305-a, while UE 115-d is within a strong geographic coverage area of geographic coverage area 120-a, of the first wireless network operated by the first wireless network operator.

FIG. 3B illustrates a geographic coverage area diagram 300-b for a base station of a second wireless network operated by a second wireless network operator belonging to the same MVNO as the first wireless network operator, in accordance with various aspects of the present disclosure. Illustrated for the same time as FIG. 3A, geographic coverage area 120-b is served by its associated base station 105-c, which may be provided by a second wireless network operator, different than the first wireless network operator. As will be further explained below, a MVNO customer may access multiple wireless networks using a DSDA or MSMA UE because of a relationship a MVNO may have with multiple wireless network operators. Thus, overlapping geographic coverage areas for a MVNO customer may be accessible to a customer UE, including both geographic coverage area 120-a for a first wireless network operated by the first wireless operator and geographic coverage area 120-b for a second wireless network operated by the second wireless operator.

Like geographic coverage area 120-a, geographic areas within geographic coverage area 120-b at a particular time may be conceptually divided into one or more geographic areas based on strength of coverage, e.g. weak coverage and strong coverage. Weak geographic coverage areas 305-d, 305-e, and 305-f represent geographic areas within geographic coverage area 120-b where a signal strength falls below a threshold. Geographic coverage area 120-b has strong coverage apart from weak geographic coverage areas 305-d, 305-e, and 305-f. As with geographic coverage area 120-a, UEs accessing the second wireless network thus may be in areas of weak coverage or strong coverage within geographic coverage area 120-b provided by the second wireless network operator. At a particular time, UE 115-c is within strong geographic coverage area of geographic coverage area 120-b, while UE 115-d is within a weak geographic coverage area 305-e, of the second wireless network.

Thus, it may happen that UE 115-c may be in an area of strong coverage in a first wireless network operated by the first wireless network operator, but an area of weak coverage in a second wireless network operated by the second wireless network operator; and UE 115-d may be in an area of weak coverage in a first wireless network operated by the first wireless network operator, but an area of strong coverage in a second wireless network operated by the second wireless network operator.

FIG. 3C illustrates a geographic coverage area diagram 300-c that is combined for first base station 105-b of a first wireless network operated by a first wireless operator and a second base station 105-c of a second wireless network operated by a second wireless operator, in accordance with various aspects of the present disclosure. UE 115-c and UE 115-d may be used in connection with a MVNO. As discussed above, a MVNO is a wireless communications services provider that does not own the wireless network infrastructure over which the MVNO provides services to its customers. Because of the MVNO relationship, UE 115-c may communicate with both the first wireless network via base station 105-b via communication link 125-a and the second wireless network base station 105-c via communication link 125-c. Likewise, UE 115-d may communicate with both the first wireless network via base station 105-b via communication link 125-b and the second wireless network base station 105-c via communication link 125-d. Thus, combined geographic coverage area 310 represents the signal strength of the combination of the first wireless network operated by the first wireless network operator belonging to the MVNO and the second wireless network operated by the second wireless network operator belonging to the MVNO when UE 115-c and UE 115-d are able to switch between the two networks, where weak geographic coverage areas have been eliminated because the UE may switch from being connected to a weak geographic coverage area to being connected to a strong geographic coverage area upon detecting that it has entered a weak geographic coverage area.

A UE connected to a first wireless network operated by a first wireless operator, and communicating with the first wireless network using its WWAN transceiver, may concurrently use the Rx chain of its WLAN transceiver to autonomously measure or scan a second wireless network operated by a second wireless operator. In a first example, a WLAN transceiver may be used to assist a WWAN transceiver in a UE in the context of operations with a MVNO associated with multiple actual networks. A MVNO may be associated with two or more “home” networks, where home network A is operated by operator A and home network B is operated by operator B. The MVNO may have agreements allowing use of both home network A and home network B. However, because home networks A and B are operated by different operators, these home networks may not configure the UE for measurements that may be made in the other home network. This may result in a challenge when the signal quality of the home network being used by a UE is poor and the UE is to autonomously scan for the other home network, both in idle as well as in connected states. When the UE is in an idle or standby state, the scanning may be done by using a single WWAN transceiver (the same WWAN transceiver used to connect to either home network), but neither home network will broadcast information for the other home network. When the UE is in a connected state, a WLAN Rx chain may be used so as to not interrupt communications with the connected home network, but the connected home network will not configure measurements on the other home network. The MVNO may prefer to allow seamless transition between home network A and home network B, so as to provide a best possible connection for the UE.

Thus, the UE may use an Rx chain of a WLAN transceiver to autonomously measure or scan another home network operated by a second wireless operator while the UE is connected to a first wireless network operated by a first wireless operator using its WWAN transceiver. For example, whenever a connected UE detects that the performance of the first wireless network is below a threshold level, the UE may use the WLAN Rx chain to scan for a second wireless network operated by a second wireless operator belonging to the same MVNO as the first wireless network operated by the first network operator. The UE may use previously stored information regarding the second wireless network channels or may obtain the information from a network server. The information may include band, bandwidth, and channel number of cells in each home network. If the performance on the first wireless network does not improve within a pre-configured time, the UE may be configured to drop the current connection with the first wireless network (via the WWAN transceiver) and establish a new connection with the second wireless network (via the WWAN transceiver). Off-line processing of cell search and decoding of system information may expedite the transition. Scanning using the WLAN Rx chain may also be delayed if the UE is using the WLAN transceiver for high-priority, delay-sensitive traffic when scanning would otherwise occur.

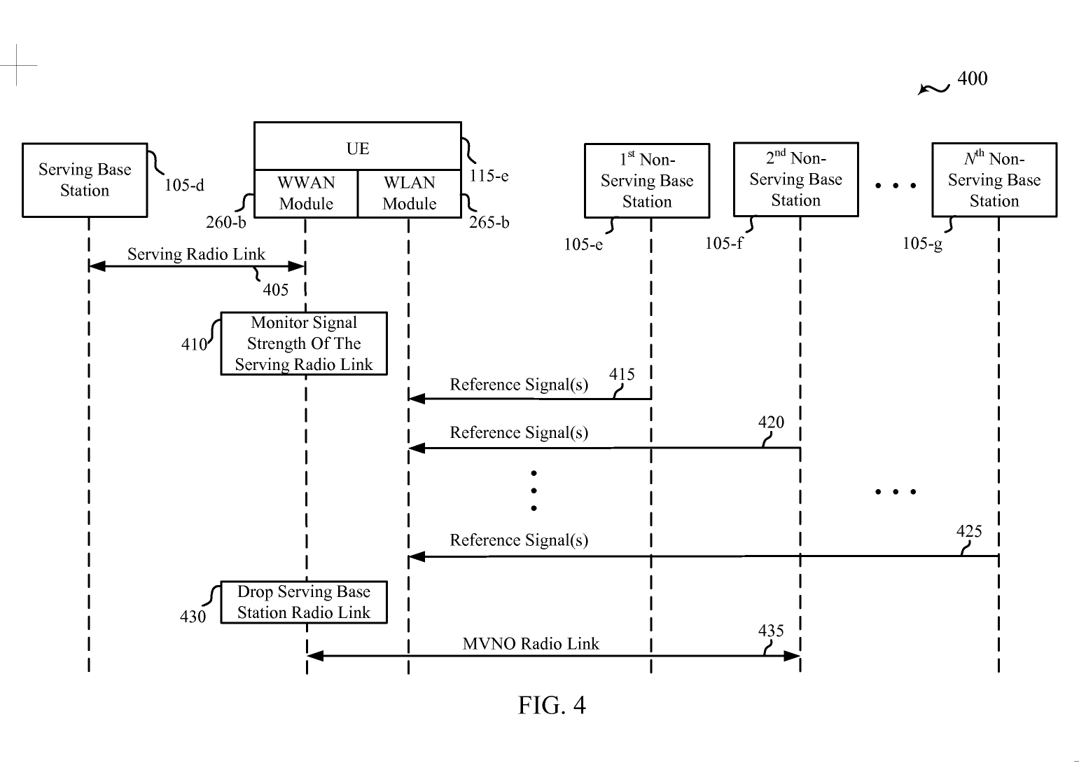

FIG. 4 shows a first example message flow 400 between a UE 115-e, a serving base station 105-d of a first wireless network, and a plurality of non-serving base stations, in accordance with various aspects of the present disclosure. There may be up to n non-serving base stations operating on one or more second wireless networks, operated by a second wireless operator belong to the MVNO, different than the first wireless network and on different frequencies, including a first non-serving base station 105-e, a second non-serving base station 105-f, and an n^{th} non-serving base station 105-g. Initially, UE 115-e is communicating with a serving base station 105-d of the first wireless network using a WWAN module 260-b of it WWAN transceiver via a serving radio link 405.

While communicating with the first wireless network the WWAN module 260-b monitors 410 a signal strength of the serving radio link 405. In some examples, this signal strength may be a reference signal received power (RSRP) and/or a reference symbols received quality (RSRQ) as measured at the UE 115-e. UE 115-e compares the signal strength against a threshold parameter, s-Measure-MVNO, to determine if the signal strength has fallen below the threshold for a predetermined period of time. The threshold may be a predetermined parameter stored internally in UE 115-e. In some examples the threshold may be based on an average of the signal strength. In other examples, the threshold may be an absolute threshold where the signal strength is below the threshold over the predetermined period of time.

Once the threshold has been surpassed, UE 115-e begins scanning the non-serving base stations on different frequencies belonging to the second wireless network using the Rx chain of WLAN module 265-b, receiving one or more reference signals 415 from the first non-serving base station 105-e, one or more reference signal 420 from the second non-serving base station 105-f, and so on to the reference signals 425 of the n^{th} non-serving base station 105-g. Reference signals from additional non-serving base stations (not shown) may also be received. Information concerning the identity of the various non-serving base stations may be provided to the UE 115-e on channels of the one or more second wireless networks, or obtained by UE 115-e from a network server of the first wireless network. UE 115-e may also store information concerning nodes or base stations to which it has previously been connected, including band, bandwidth, and/or channel number. Although the reference signals 415, reference signals 420, and reference signals 425 are shown arriving according to an order, they may be received and measured by UE 115-e in a variety of orders. The signal strengths of the non-serving base stations may be calculated from the reference signals.

UE 115-e may monitor the signal strengths of the non-serving base station using the WLAN module 265-b and the signal strength of the serving radio link using WWAN module 260-b while continuing to communicate with the serving base station 105-d over the serving radio link 405. UE 115-e may then determine a candidate cell among the non-serving base stations, for example second non-serving base station 105-f UE 115-e may the make the decision to transition the serving radio link to the second non-serving base station 105-f, when the signal strength (RSRP and/or RSRQ) of the second non-serving base station 105-f is above a first threshold, Threshold_{MVNO, OtherNetwork}, and the signal strength (RSRP and/or RSRQ) of the serving base station 105-d is above a second threshold, Threshold_{MVNO, CurrentNetwork}, for a predetermined period of time, TTT_{MVNO}. In some examples the first and second thresholds may be based on an average of the signal strength over TTT_{MVNO}. In other examples, the threshold may be an absolute threshold where the signal strength may be disallowed from surpassing the threshold during the predetermined time period, TTT_{MVNO}.

Once the decision to transition has been made, the WWAN module 260-b drops 430 the serving base station radio link, and UE 115-e establishes a MVNO radio link 435 with second non-serving base station 105-f, which is in the second wireless network operated by the second operator belonging to the same MVNO.

If instead of using the WLAN Rx chain of the WLAN module 265-b, the WWAN Rx chain of the WWAN module 260-b were used, it may be necessary to tune away because a base station on the first wireless network operated by a first operator would not configure measurement gaps for measurements on a second wireless network operated by a second wireless operator. Thus, quality of experience can be improved especially in area with poor radio frequency (RF) conditions, for example at the edge of cells, where a UE may miss retransmission opportunities (uplink and downlink), due to tuning away.

In a second example, a Rx chain of a WLAN transceiver in a first wireless network may be used to assist a Rx chain of a WWAN transceiver in the UE in the context of taking measurements from a number of base stations, including from neighboring cells, that may be used to identify a UE's position. Currently, a WWAN transceiver may be used to take a number of measurements of neighboring cells of the serving cell to determine position. One such measurement type is an observed time difference of arrival (OTDOA) measurement used to estimate a UE's position. An OTDOA measurement may be based on UE estimates of time differences between when the UE receives a number of positioning reference signals (PRSs) from the neighboring cells. According to the LTE positioning protocol (LPP), up to twenty-four (24) neighboring cells may each send OTDOA assistance data on up to three (3) different frequencies. The OTDOA assistance data includes a list of cells (base stations), and parameters for their PRSs, including bandwidth, periodicity, etc., of the PRSs. The UE then performs a set of reference signal time difference (RSTD) measurements based on observed time offsets between the PRSs from the different cells of the list of cells that the UE was able to measure. This information may then be used to estimate the position of the UE.

Various factors may lengthen the time required to perform the actions needed to take an OTDOA measurement. The RSTD measurements may be a mix of both inter-frequency and intra-frequency measurements. Inter-frequency measurements on two or more frequencies may need to be performed serially, i.e. may not be performed simultaneously, which adds delay to the measurement process. Also, if any of the PRS measurement occasions overlap with the serving frequency, then the inter-frequency and intra-frequency measurements also need to be serialized, which may add further delay. Finally, a single measurement of each cell may be inadequate; multiple measurements of the same cell can also add delay to the OTDOA measurement process. This increased delay may be problematic for certain applications, including for enhanced 911 service applications.

Given the physical layer cell identities of neighbor cells and OTDOA assistance data, a UE may be able to detect and measure inter-frequency RSTD using the Rx chain of a WLAN transceiver within a time given by according to the following equation: T_{RSTD InterFreqFDD, E-UTRAN}=T_{PRS}·(M−1)+Δ, where T_{RSTD InterFreqFDD, E-UTRAN} is the total time for detecting and measuring at least n cells. T_{PRS} may be defined as the largest value of the cell-specific positioning subframe configuration period among the measured n cells, including the reference cell. M may be the number of PRS positioning occasions. Delta (A) is the measurement time for a single PRS positioning occasion which includes the sampling time and the processing time, where n cells are distributed on up to two carrier frequencies including a serving carrier frequency and one inter-frequency carrier. Delta (A) may be expressed by following equation:

$$Δ = 160 ms \cdot ⌈ \frac{n}{M} ⌉ ,$$

where ms is milliseconds.

The number of PRS positioning occasions M may be determined according to the subframe configuration period T_{PRS} and based on inter-frequency RSTD measurements are performed over the serving cell and neighbor cells on an inter-frequency carrier frequency, i.e. a frequency other than the serving carrier frequency. For example, for a subframe configuration period T_{PRS}=160 ms, there may be M=16 PRS positioning occasions within T_{RSTD InterFreqFDD, E-UTRAN}. In another example, for T_{PRS}>160 ms, there may be M=8 PRS positioning occasions.

However, the number of PRS positioning occasions M may also be determined according to the subframe configuration period T_{PRS} based on inter-frequency RSTD measurements that are performed over the serving cell on the serving carrier frequency and performed over the neighbor cells on the inter-frequency carrier frequency. For example, for a subframe configuration period T_{PRS}=160 ms, there may be M=32 PRS positioning occasions within T_{RSTD InterFreqFDD, E-UTRAN}. In another example, for T_{PRS}>160 ms, there may be M=16 PRS positioning occasions.

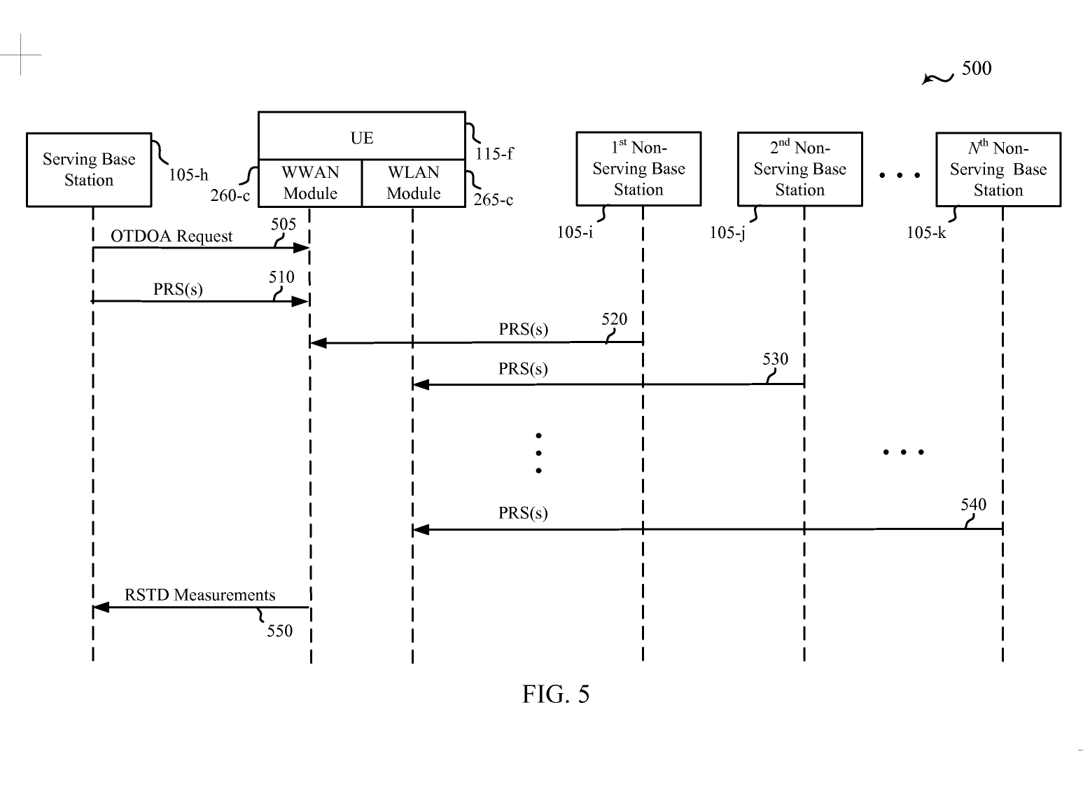

FIG. 5 shows a second example message flow 500-a between a UE 115-f, a serving base station 105-h, and a plurality of non-serving base stations, in accordance with various aspects of the present disclosure. There may be up to n non-serving base stations, including a first non-serving base station 105-i, a second non-serving base station 105-j, and an n^{th} non-serving base station 105-k. Initially, UE 115-f is in wireless communication with a serving base station 105-h of the wireless network using a WWAN transceiver of its WWAN module 260-c via a serving radio link.

The serving base station 105-h may make an OTDOA request 505 of UE 115-f. In response, UE 115-f may scan for PRSs from the serving base station 105-h as well as the non-serving base stations using both the WWAN module 260-c and WLAN module 265-c. Specifically, WWAN module 260-c may take intra-frequency RSTD measurements using the Rx chain of its WWAN transceiver, while the WLAN module 265-c may take inter-frequency RSTD measurements using the Rx chain of its WLAN transceiver. WWAN module 260-c may receive and measure, via its Rx chain, one or more PRSs 510 from the serving base station 105-h, and one or more PRSs from non-serving base stations in the same frequency layer as the serving base station 105-h, i.e. intra-frequency PRSs, including PRSs 520 from the first non-serving base station 105-i. Note that only one non-serving base station 105-i in the same frequency layer as the serving base station 105-h is shown in FIG. 5, but PRSs may be taken by the Rx chain of the WWAN transceiver from additional non-serving base stations in the same frequency layer as well. During the same time period as the inter-frequency RSTD measurements by the WWAN Rx chain, WLAN module 265-c may receive and measure, via its Rx chain, one or more PRSs 530 from the second non-serving base station 105-j and so on to the PRSs 540 of the n^{th} non-serving base station 105-k. These PRSs may be inter-frequency PRSs. Note that for clarity, FIG. 5 illustrates PRSs 530 and PRSs 540 as received by UE 115-e after PRSs 510 and PRSs 520; however, PRSs may be received by the WWAN module 260-c in parallel, i.e. during time periods overlapping with receipt of PRSs by WLAN module 265-c. Based on the received PRSs, UE 115-f then calculates a set of RSTD measurements 550 that it sends to the first wireless network via serving base station 105-h. Processing of the RSTD measurements can be performed by a WWAN modem or as part of the WLAN receive chain. Performing the intra-frequency measurements in parallel with the inter-frequency measurements means that more cells may be measured, including across different frequency layers, within a certain period of time, increasing the position accuracy. Relatedly, performing the intra-frequency measurements in parallel with the inter-frequency measurements also means that the same number of cells may be measured in a shorter period of time, which expedites a determination of position location.

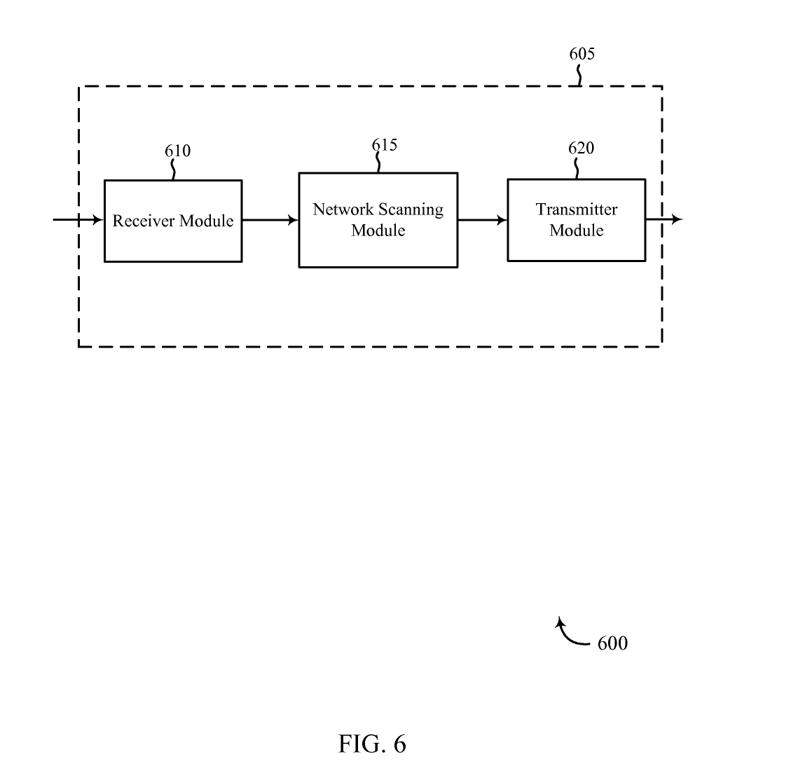

FIG. 6 shows a block diagram 600 of an apparatus 605 for use in a wireless device for wireless communication, in accordance with various aspects of the present disclosure. In some examples, the apparatus 605 may be an example of aspects of one or more of the UEs 115 described with reference to FIGS. 1, 2, 3, 4, and/or 5. The apparatus 605 may also be or include a processor (not shown). The apparatus 605 may include a receiver module 610, a network scanning module 615, and/or a transmitter module 620. Each of these modules may be in communication with each other.

The apparatus 605 may be configured, through its receiver module 610, the network scanning module 615, and/or the transmitter module 620, may be configured to perform functions described herein. For example, the apparatus 605 may be configured to use a WLAN transceiver to autonomously measure or scan a second wireless network while the apparatus 605 is communicatively connected to a first wireless network using its WWAN transceiver.

The components of the apparatus 605 may, individually or collectively, be implemented using one or more ASICs adapted to perform some or all of the applicable functions in hardware. Alternatively, the functions may be performed by one or more other processing units (or cores), on one or more integrated circuits. In other examples, other types of integrated circuits may be used (e.g., Structured/Platform ASICs, FPGAs, and other Semi-Custom ICs), which may be programmed in any manner known in the art. The functions of each component may also be implemented, in whole or in part, with instructions embodied in a memory, formatted to be executed by one or more general or application-specific processors.

The receiver module 610 may receive information such as packets, user data, and/or control information associated with various information channels (e.g., control channels, data channels, etc.). The receiver module 610 may be configured to receive, from one or more base stations of one or more wireless networks, OTDOA assistance data, OTDOA requests, and reference signals including PRSs. Information may be passed on to the network scanning module 615, and to other components of the apparatus 605.

The transmitter module 620 may transmit the one or more signals received from other components of the apparatus 605. The transmitter module 620 may transmit, from one or more base stations of one or more wireless networks, RSTD measurements and other messaging responsive to an OTDOA request. In some examples, the transmitter module 620 may be collocated with the receiver module 610 in a transceiver module. The transmitter module 620 may include a single antenna, or it may include a plurality of antennas.

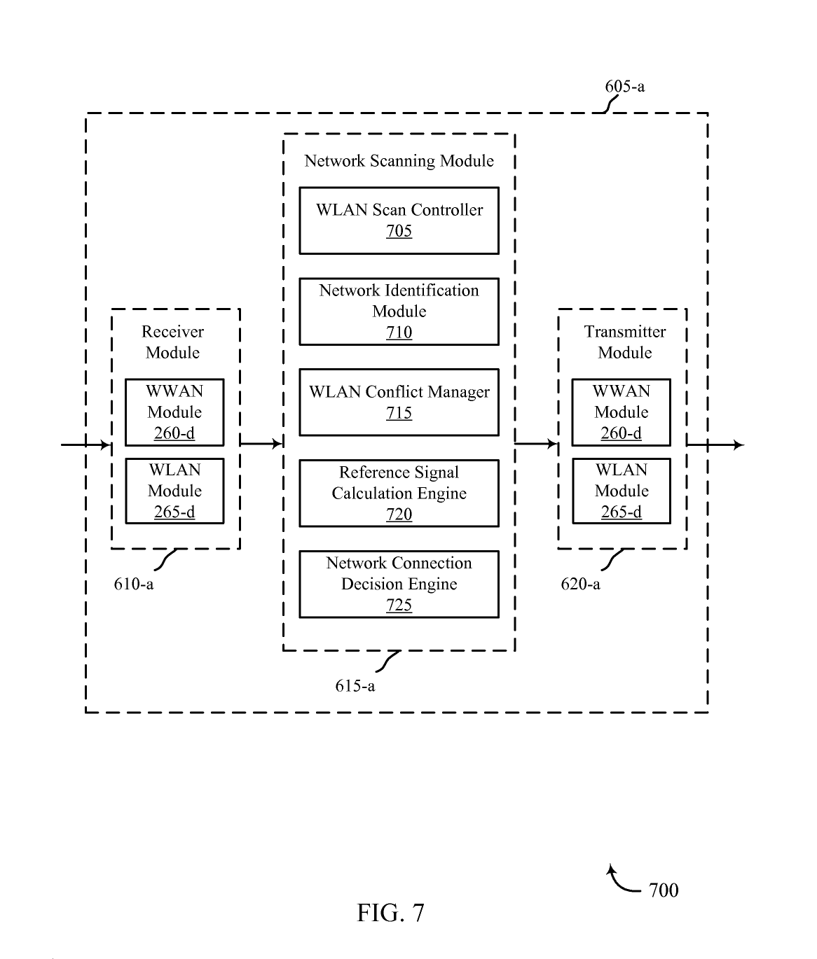

FIG. 7 shows a block diagram 700 of an apparatus 605-a for use in wireless communication, in accordance with various aspects of the present disclosure. The apparatus 605-a may be an example of one or more aspects of a UE 115 described with reference to FIGS. 1, 2, 3, 4, 5, and/or 6. The apparatus 605-a may include a receiver module 610-a, a network scanning module 615-a, and/or a transmitter module 620-a. The apparatus 605-a may also include a processor (not shown). Each of these components may be in communication with each other.

The receiver module 610-a may include a WWAN module 260-d and a WLAN module 265-d. The WWAN module 260-d may be used for processing a received WWAN communication. The WWAN module 260-d may include some or all of the components of Tx and Rx chains of a WWAN modem. The WWAN module 260-d may also route the received WWAN communication to the WLAN module 265-d for processing. The WLAN module 265-d may include some or all of the components of Tx and Rx chains of a WLAN modem. The WLAN module 265-d may process both WLAN and WWAN communications. The WWAN communications may be processed by a portion of the components in the WLAN module 265-d, and then passed to the network scanning module 615-a for baseband processing.

The network scanning module 615-a may include some or all of the components of the WWAN module 260-d and/or WLAN module 265-d, and/or control the operation of the WWAN module 260-d and WLAN module 265-d. The network scanning module 615-a may support one or more SIMs (not shown) for communication over one or more communications networks according to one or more subscriptions. The network scanning module 615-a may support WLAN communications at the same time as or at different times than WWAN communications. The network scanning module 615-b may include a WLAN scan controller 705, a network identification module 710, a WLAN conflict manager 715, a reference signal calculation engine 720, and a network connection decision engine 725.

The WLAN scan controller 705 controls the Rx chain of the WLAN transceiver to scan and/or measure a wireless network for reference signals, based on identification information regarding the nodes or base stations of the first and/or second wireless network and WLAN conflicts.

The network identification module 710 accesses identification information regarding the nodes or base stations of the first and/or second wireless network. Such information may include band, bandwidth, and/or channel number of nodes or base stations 105 in each wireless network. The network identification module 710 may receive such information at receiver module 610-a from channels of the one or more second wireless networks or from a network server of the first and/or second wireless networks. The network identification module 710 may also retrieve information concerning nodes or base stations to which apparatus 605-a has previously been connected, e.g. in memory 815 described below.

The WLAN conflict manager 715 manages conflicts between the desired use of the WLAN transceiver to scan, measure, and/or otherwise access and wireless network and use of the WLAN transceiver for WLAN functions such as Wi-Fi, Bluetooth, etc.

The reference signal calculation engine 720, calculates one or more, or a set, of RSTD measurements for an OTDOA measurement according to received reference signals, including PRSs, from a wireless network.

The network connection decision engine 725 compares signal strengths signals received from one or more of the wireless networks against one or more predetermined thresholds to decide whether to switch from a current serving base station to a non-serving base station.

The transmitter module 620-a may be co-located with the receiver module 610-a and may also include the WWAN module 260-d and the WLAN module 265-d. The WWAN module 260-d may be used for processing a WWAN communication prior to transmission. The WLAN module 265-d may process both WLAN and WWAN communications prior to transmission. The WWAN communication may be processed by a portion of the components in the WLAN module 265-d. The WLAN module 265-d may then route the WWAN communication to the WWAN module 260-d for further processing and transmission over a WWAN antenna.

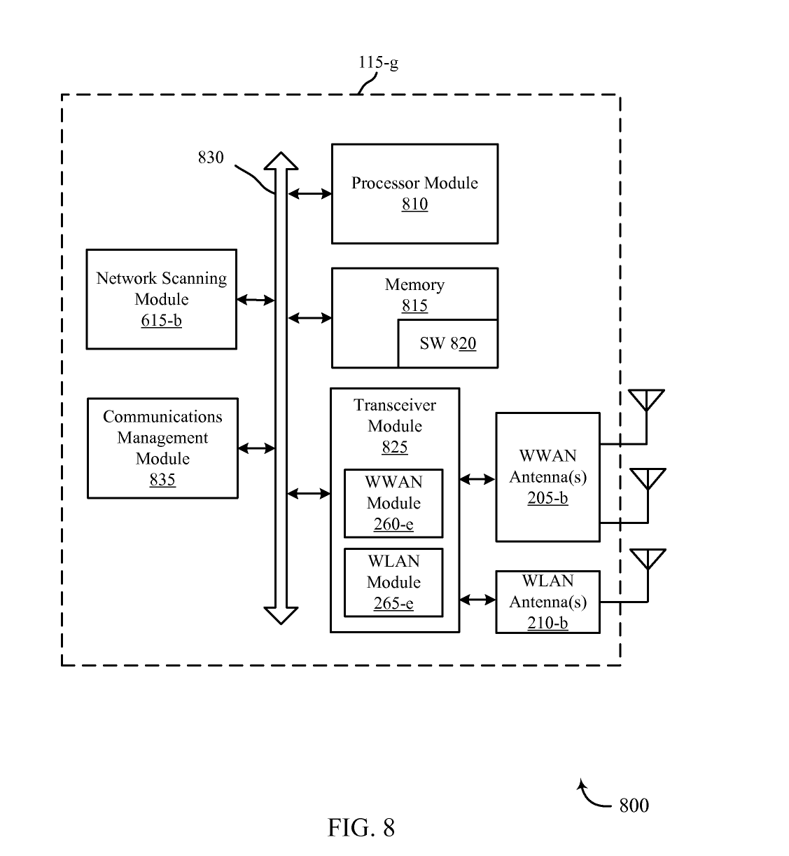

FIG. 8 shows a system 800 for use in wireless communication, in accordance with various examples. System 800 may include a UE 115-g, which may be an example of the UEs 115 of FIGS. 1, 2, 3, 4, and/or 5. UE 115-g may also be an example of one or more aspects of apparatus 605 of FIGS. 6 and/or 7.

The UE 115-g may generally include components for bi-directional voice and data communications including components for transmitting communications and components for receiving communications. The UE 115-g may include WWAN antenna(s) 205-b, WLAN antenna(s) 210-b, a transceiver module 825, a processor module 810, and memory 815 (including software (SW) 820), which each may communicate, directly or indirectly, with each other (e.g., via one or more buses 830). The transceiver module 825 may be configured to communicate bi-directionally, via the WWAN antenna(s) 205-b, the WLAN antenna(s) 210-b, and/or one or more wired or wireless links, with one or more networks, as described above. For example, the transceiver module 825 may be configured to communicate bi-directionally with base stations 105 and with the access points 110 with reference to FIGS. 1, 3, 4, and/or 5. The transceiver module 825 may include a WWAN module 260-e configured to modulate the packets and provide the modulated packets to the WWAN antenna(s) 205-b for transmission, and to demodulate packets received from the WWAN antenna(s) 205-b.

The UE 115-g may have multiple WWAN antenna(s) 205-b capable of concurrently transmitting and/or receiving multiple wireless communications. The transceiver module 825 may be capable of concurrently communicating with one or more base stations 105 via multiple component carriers and/or communications networks. Additionally, the transceiver module 825 may include a WLAN module 265-e configured to modulate the packets and provide the modulated packets to the WLAN antenna(s) 210-b for transmission, and to demodulate packets received from the WLAN antenna(s) 210-b. The UE 115-g may have multiple WLAN antenna(s) 210-b capable of concurrently transmitting and/or receiving multiple wireless communications. The transceiver module 825 may be capable of communicating with one or more access points 110 via the WLAN antenna(s) 210-b. The transceiver module 825 may use a portion of the components in the WLAN module 265-e to process WWAN communications received over the WWAN antenna(s) 205-b. The transceiver module 825 may also use a portion of the components in WLAN module 265-e to process WWAN communications prior to transmission over the WWAN antenna(s) 205-b.

The UE 115-g may include a network scanning module 615-b, which may perform the functions described above for the network scanning module 615-a of apparatus 605 of FIGS. 6 and 7 and/or of UE 115 of FIGS. 3, 4, and/or 5.

The memory 815 may include random access memory (RAM) and read-only memory (ROM). The memory 815 may store computer-readable, computer-executable software/firmware code 820 containing instructions that are configured to, when executed, cause the processor module 810 to perform various functions described herein (e.g., use a WLAN transceiver to autonomously measure or scan a second wireless network while the UE is connected to a first wireless network using its WWAN transceiver, etc.). Alternatively, the computer-readable, computer-executable software/firmware code 820 may not be directly executable by the processor module 810 but be configured to cause a computer (e.g., when compiled and executed) to perform functions described herein. The processor module 810 may include an intelligent hardware device, e.g., a central processing unit (CPU), a microcontroller, an application-specific integrated circuit (ASIC), etc.

UEs 115-g may further include a communications management module 835. The communications management module 835 may manage communications with various access points/base stations. The communications management module 835 may be a component of the UE 115-g in communication with some or all of the other components of the UE 115-g over the at least one buses 830. Alternatively, functionality of the communications management module 835 may be implemented as a component of the transceiver module 825, including WWAN module 260-e and/or WLAN module 265-e, as a computer program product, and/or as at least one controller element of the processor module 810.

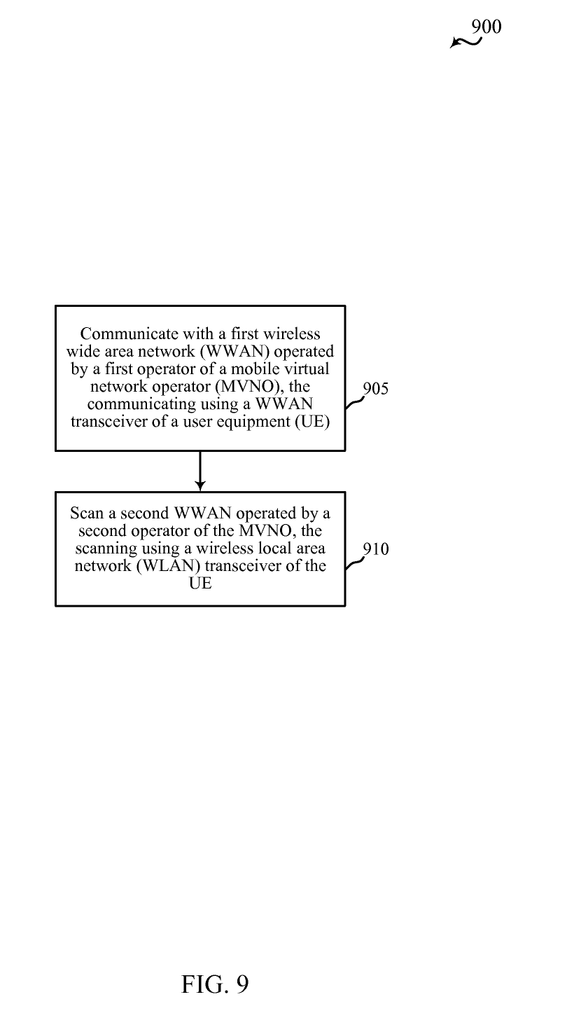

The components of the UE 115-g may be configured to implement aspects discussed above with respect to FIGS. 4 and/or 5, and those aspects may not be repeated here for the sake of brevity. Moreover, the components of the UE 115-g may be configured to implement aspects discussed below with respect to FIGS. 9, 10, 11, and/or 12, and those aspects may not be repeated here also for the sake of brevity.

FIG. 9 is a flow chart illustrating a first example of a method 900 for wireless communication, in accordance with various aspects of the present disclosure. For clarity, the method 900 is described below with reference to aspects of one or more of the UEs described with reference to FIGS. 1, 2A, 2B, 6, 7, and/or 8. In some examples, a UE may execute one or more sets of codes to control the functional elements of the UE to perform the functions described below. Additionally or alternatively, the UE may perform one or more of the functions described below using-purpose hardware.

At block 905, the method 900 may include communicating with a first WWAN operated by a first operator of a MVNO, the communicating using a WWAN transceiver of a UE. Such operation may be in accord with one or more of the message flows shown and described with respect to FIG. 4.

At block 910, the method 900 may include scanning a second WWAN operated by a second operator of the MVNO, the scanning using a WLAN transceiver of the UE. Such operation may be in accord with one or more of the message flows shown and described with respect to FIG. 4.

The operations at blocks 905 and 910 may be performed using the network scanning module 615 described with reference to FIGS. 6, 7, and 8.

Thus, the method 900 may provide for wireless communication. It should be noted that the method 900 is just one implementation and that the operations of the method 900 may be rearranged or otherwise modified such that other implementations are possible.

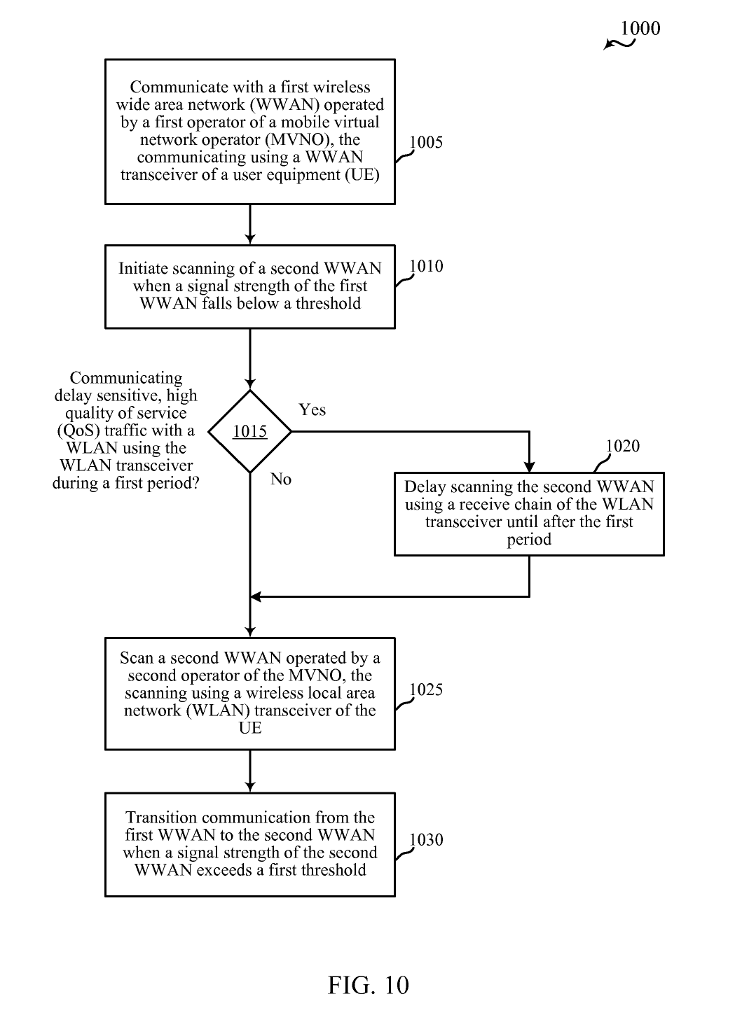

FIG. 10 is a flow chart illustrating a first example of a method 1000 for wireless communication, in accordance with various aspects of the present disclosure. For clarity, the method 1000 is described below with reference to aspects of one or more of the UEs described with reference to FIGS. 1, 2A, 2B, 6, 7, and/or 8. In some examples, a UE may execute one or more sets of codes to control the functional elements of the UE to perform the functions described below. Additionally or alternatively, the UE may perform one or more of the functions described below using-purpose hardware.

At block 1005, the method 1000 may include communicating with a first WWAN operated by a first operator of a MVNO, the communicating using a WWAN transceiver of a UE. Such operation may be in accord with one or more of the message flows shown and described with respect to FIG. 4.

At block 1010, the method 1000 may include initiating scanning of a second WWAN when a signal strength of the first WWAN falls below a threshold. Such operation may be in accord with one or more of the message flows shown and described with respect to FIG. 4.

At block 1015, the method 1000 may include a decision: is the WLAN transceiver communicating delay sensitive, high quality of service (QoS) traffic with a WLAN a first period? Such operation may be in accord with one or more of the message flows shown and described with respect to FIG. 4.

At block 1020, if the decision at block 1015 is answered in the affirmative, the method 1000 may include delaying scanning the second WWAN using a receive chain of the WLAN transceiver until after the first period. Such operation may be in accord with one or more of the message flows shown and described with respect to FIG. 4.

At block 1025, if the decision at block 1015 is answered in the negative, the method 1000 may include scanning a second WWAN operated by a second operator of the MVNO, the scanning using a WLAN transceiver of the UE. Such operation may be in accord with one or more of the message flows shown and described with respect to FIG. 4.

At block 1030, the method 1000 may include transitioning communication from the first WWAN to the second WWAN when a signal strength of the second WWAN exceeds a first threshold. Such operation may be in accord with one or more of the message flows shown and described with respect to FIG. 4.

Thus, the method 1000 may provide for wireless communication. It should be noted that the method 1000 is just one implementation and that the operations of the method 1000 may be rearranged or otherwise modified such that other implementations are possible.

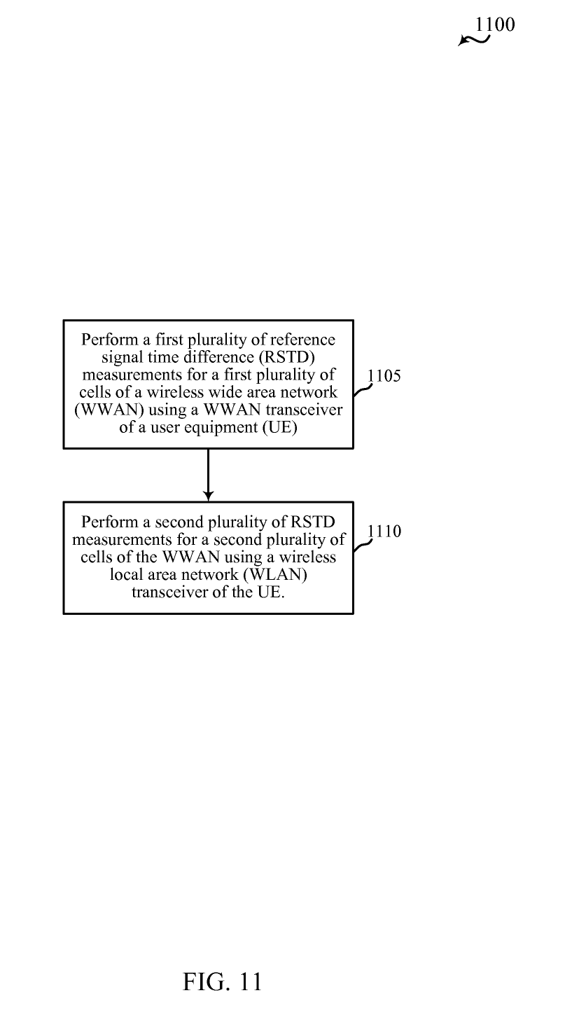

FIG. 11 is a flow chart illustrating a first example of a method 1100 for wireless communication, in accordance with various aspects of the present disclosure. For clarity, the method 1100 is described below with reference to aspects of one or more of the UEs described with reference to FIGS. 1, 2A, 2B, 6, 7, and/or 8. In some examples, a UE may execute one or more sets of codes to control the functional elements of the UE to perform the functions described below. Additionally or alternatively, the UE may perform one or more of the functions described below using-purpose hardware.

At block 1105, the method 1100 may include performing a first plurality of RSTD measurements for a first plurality of cells of a WWAN using a WWAN transceiver of a UE. Such operation may be in accord with one or more of the message flows shown and described with respect to FIG. 5.

At block 1110, the method 1100 may include performing a second plurality of RSTD measurements for a second plurality of cells of the WWAN using a wireless local area network (WLAN) transceiver of the UE. Such operation may be in accord with one or more of the message flows shown and described with respect to FIG. 5.

The operations at blocks 1105 and 1110 may be performed using the network scanning module 615 described with reference to FIGS. 6, 7, and 8.

Thus, the method 1100 may provide for wireless communication. It should be noted that the method 1100 is just one implementation and that the operations of the method 1100 may be rearranged or otherwise modified such that other implementations are possible.

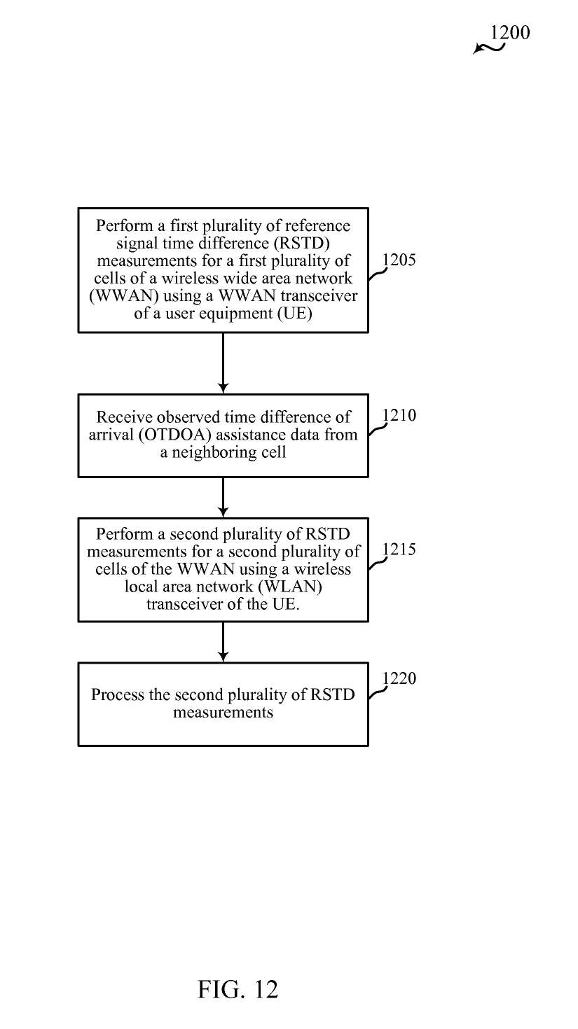

FIG. 12 is a flow chart illustrating a first example of a method 1200 for wireless communication, in accordance with various aspects of the present disclosure. For clarity, the method 1200 is described below with reference to aspects of one or more of the UEs described with reference to FIGS. 1, 2A, 2B, 6, 7, and/or 8. In some examples, a UE may execute one or more sets of codes to control the functional elements of the UE to perform the functions described below. Additionally or alternatively, the UE may perform one or more of the functions described below using-purpose hardware.

At block 1205, the method 1200 may include performing a first plurality of RSTD measurements for a first plurality of cells of a WWAN using a WWAN transceiver of a UE. Such operation may be in accord with one or more of the message flows shown and described with respect to FIG. 5.

At block 1210, the method 1200 may include receiving OTDOA assistance data from a neighboring cell. Such operation may be in accord with one or more of the message flows shown and described with respect to FIG. 5.

At block 1215, the method 1200 may include performing a second plurality of RSTD measurements for a second plurality of cells of the WWAN using a WLAN transceiver of the UE. Such operation may be in accord with one or more of the message flows shown and described with respect to FIG. 5.

At block 1220, the method 1200 may include processing the second plurality of RSTD measurements. Such operation may be in accord with one or more of the message flows shown and described with respect to FIG. 5.

Thus, the method 1200 may provide for wireless communication. It should be noted that the method 1200 is just one implementation and that the operations of the method 1200 may be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

1. A method for wireless communication, comprising:
communicating with a first wireless wide area network (WWAN) operated by a first operator of a mobile virtual network operator (MVNO), the communicating using a WWAN transceiver of a user equipment (UE); and
scanning a second WWAN operated by a second operator of the MVNO, the scanning using a wireless local area network (WLAN) transceiver of the UE.

2. The method of claim 1, further comprising:
initiating the scanning of the second WWAN when a signal strength of the first WWAN falls below a threshold.

3. The method of claim 1, further comprising:
transitioning communication from the first WWAN to the second WWAN when a signal strength of the second WWAN exceeds a first threshold.

4. The method of claim 1, wherein scanning the second WWAN using the WLAN transceiver comprises:
scanning the second WWAN using a receive chain of the WLAN transceiver.

5. The method of claim 1, further comprising:
communicating with a WLAN using the WLAN transceiver during a first period; and
delaying scanning the second WWAN using a receive chain of the WLAN transceiver until after the first period.

6. The method of claim 5, wherein communicating with the WLAN using the WLAN transceiver during the first period further comprises:
receiving delay sensitive traffic.

7. The method of claim 5, wherein communicating with the WLAN using the WLAN transceiver during the first period further comprises:
receiving voice traffic, video traffic, or both voice and video traffic.

8. The method of claim 1, further comprising:
communicating with a WLAN using the WLAN transceiver during a first period and a second period immediately following the first period; and
scanning the second WWAN using the WWAN transceiver during the second period when the first period exceeds a threshold.

9. The method of claim 1, further comprising:
storing an identifying information for a plurality of cells in the second WWAN.

10. The method of claim 9, wherein the identifying information comprises at least one of band, bandwidth, or channel number information.

11. The method of claim 1, further comprising:
storing identifying information for one or more cells to which the UE has previously been connected.

12. The method of claim 1, further comprising:
retrieving, from a WWAN server, identifying information for a plurality of cells in the second WWAN.

13. The method of claim 1, further comprising:
transitioning communication from the first WWAN to the second WWAN if a second signal strength of the second WWAN exceeds a first threshold and a first signal strength of the first WWAN remains below a second threshold for a predetermined period of time.

14. The method of claim 1, wherein scanning the second WWAN is initiated based at least in part on an internal trigger of the UE.

15. The method of claim 1, wherein scanning the second WWAN is not based on a configuration received from the second WWAN.

16-23. (canceled)

24. An apparatus for wireless communication, comprising:
a processor;
memory in electronic communication with the processor; and
instructions stored in the memory, the instructions being executable by the processor to:
communicate with a first wireless wide area network (WWAN) operated by a first operator of a mobile virtual network operator (MVNO), the communicating using a WWAN transceiver of a user equipment (UE); and
scan a second WWAN operated by a second operator of the MVNO, the scanning using a wireless local area network (WLAN) transceiver of the UE.

25. The apparatus of claim 24, wherein the instructions stored in the memory further comprise instructions executable by the processor to:
initiate scanning of the second WWAN when a signal strength of the first WWAN falls below a threshold.

26. The apparatus of claim 24, wherein the instructions stored in the memory further comprise instructions executable by the processor to:
transition communication from the first WWAN to the second WWAN when a signal strength of the second WWAN exceeds a first threshold.

27. The apparatus of claim 24, wherein the instructions stored in the memory further comprise instructions executable by the processor to:
scan the second WWAN using a receive chain of the WLAN transceiver.

28-30. (canceled)

31. The apparatus of claim 24, wherein the instructions stored in the memory further comprise instructions executable by the processor to:
communicate with a WLAN using the WLAN transceiver during a first period; and
delay scanning the second WWAN using a receive chain of the WLAN transceiver until after the first period.

32. The apparatus of claim 24, wherein the instructions stored in the memory further comprise instructions executable by the processor to:
communicate with a WLAN using the WLAN transceiver during a first period and a second period immediately following the first period; and
scan the second WWAN using the WWAN transceiver during the second period when the first period exceeds a threshold.

33. The apparatus of claim 24, wherein the instructions stored in the memory further comprise instructions executable by the processor to:
store an identifying information for a plurality of cells in the second WWAN.

34. An apparatus for wireless communication, comprising:
means for communicating with a first wireless wide area network (WWAN) operated by a first operator of a mobile virtual network operator (MVNO), the means for communicating using a WWAN transceiver of a user equipment (UE); and
means for scanning a second WWAN operated by a second operator of the MVNO, the means for scanning using a wireless local area network (WLAN) transceiver of the UE.

35. The apparatus of claim 34, further comprising:
means for initiating scanning of the second WWAN when a signal strength of the first WWAN falls below a threshold.

36. The apparatus of claim 34, further comprising:
means for transitioning communication from the first WWAN to the second WWAN when a signal strength of the second WWAN exceeds a first threshold.

37. The apparatus of claim 34, further comprising:
means for communicating with a WLAN using the WLAN transceiver during a first period; and
means for delaying scanning the second WWAN using a receive chain of the WLAN transceiver until after the first period.

38. A non-transitory computer-readable medium storing code for wireless communication, the code comprising instructions executable by a processor to:
communicate with a first wireless wide area network (WWAN) operated by a first operator of a mobile virtual network operator (MVNO), the communicating using a WWAN transceiver of a user equipment (UE); and
scan a second WWAN operated by a second operator of the MVNO, the scanning using a wireless local area network (WLAN) transceiver of the UE.

39. The non-transitory computer-readable medium of claim 38, wherein the instructions are further executable by the processor to:
initiate scanning of the second WWAN when a signal strength of the first WWAN falls below a threshold.

40. The non-transitory computer-readable medium of claim 38, wherein the instructions are further executable by the processor to:
transition communication from the first WWAN to the second WWAN when a signal strength of the second WWAN exceeds a first threshold.

41. The non-transitory computer-readable medium of claim 38, wherein the instructions are further executable by the processor to:
communicate with a WLAN using the WLAN transceiver during a first period; and
delay scanning the second WWAN using a receive chain of the WLAN transceiver until after the first period.
